(19) United States
(12) Patent Application Publication
(10) Pub. No.: US 2011/0294102 A1
(43) Pub. Date: Dec. 1, 2011

(54) DENTAL HYGIENE INSTRUCTIONAL DEVICE

(76) Inventor: Daniel G. Goldwin, Chicago, IL (US)

(21) Appl. No.: 12/955,314

(22) Filed: Nov. 29, 2010

Related U.S. Application Data
(60) Provisional application No. 61/265,086, filed on Nov. 30, 2009.

(51) Int. Cl. G09B 23/30

(52) U.S. Cl. 434/263

(57) ABSTRACT

A dental hygiene instructional apparatus comprising a three dimensional figure with an open mouth and a plurality of simulated, three dimensional upper teeth protruding downwardly from an upper surface of the open mouth in an arc shaped pattern and a plurality of simulated, three dimensional lower teeth protruding upwardly from a lower surface of the open mouth in an arc shaped pattern. At least one light emitting source is positioned within each of the upper teeth and the lower teeth so that each of the upper teeth and the lower teeth may be individually illuminated during successive intervals of time.

### CROSS REFERENCE TO RELATED APPLICATIONS

This application claims benefit of U.S. Provisional Application No. 61/265,086, filed Nov. 30, 2009, which is incorporated herein by reference in its entirety.

### BACKGROUND OF THE PRESENTLY DISCLOSED AND/OR CLAIMED INVENTIVE CONCEPTS

1. Field of Presently Disclosed and/or Claimed Inventive Concepts

The inventive concepts disclosed and claimed herein relate generally to a three-dimensional interactive, audio and visual display with timing and storage components designed to promote proper dental hygiene by guiding children through the locations and timing required for proper teeth brushing.

2. Brief Description of Related Art

Parents, educators, and dental professionals have long used two-dimensional or stationary devices or simple timers to show children how, where, and for how long they should brush their teeth. It is accepted by dental professionals that frequent teeth brushing alone does not guarantee good dental health. Rather, for brushing to be effective, not only must it be done regularly (the general recommendation is after each meal, which normally means three times per day) and for the right amount of time (two minutes is the generally accepted duration), but all teeth must be brushed, not just the ones that are most readily visible, namely the front teeth.

Devices that are currently available have not focused on ensuring that children brush all of their teeth for the proper amount of time. This is because currently available tools work from two-dimensional representations of the mouth that do not remind or show children how to brush those teeth they cannot see, namely those in the back of their mouth. Additionally, one of the most challenging aspects of teaching children how to brush their teeth is finding a way to keep their attention, thereby keeping them engaged in the brushing process and helping them to see brushing their teeth as something more than a chore that must be finished as fast as possible.

Compact Discs (CDs), Digital Video Discs (DVDs), computer or video games, and posters are all unsuited for bathroom use. Devices that lack depth or an open mouthed representation fail to properly teach children because they only represent the front or visible teeth. Certain currently available devices that show an entire mouth, including the back teeth are two-dimensional and fail because children have a difficult time associating a two-dimensional representation of a mouth with their mouth. Devices that merely provide a timing mechanism account for the overall duration of brushing, but not the need to brush all teeth. Finally, available devices, including those discussed above fail to hold children's attention span and keep them focused on brushing for the recommended time.

To this end, a need exists for an improved device for promoting dental hygiene. It is to such a device that the inventive concepts disclosed and claimed herein are directed.

### BRIEF DESCRIPTION OF THE DRAWINGS

FIG. 1 is a perspective view of a three dimensional dental hygiene instructional device constructed in accordance with the inventive concepts disclosed herein displaying an open mouth exhibiting simulated, three dimensional teeth.

FIG. 2 is a side elevational view of the three dimensional dental hygiene instructional device of FIG. 1.

### DETAILED DESCRIPTION OF EXEMPLARY EMBODIMENTS

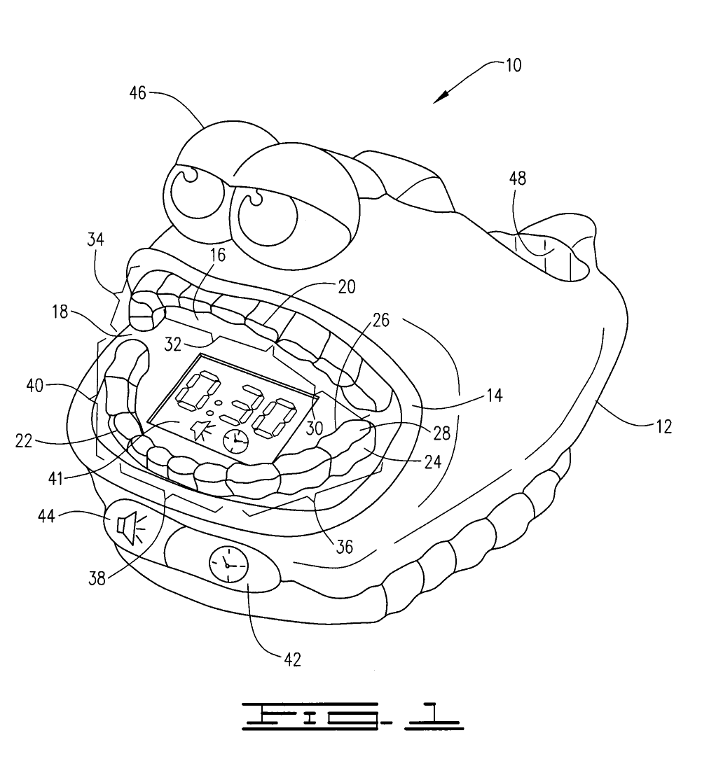

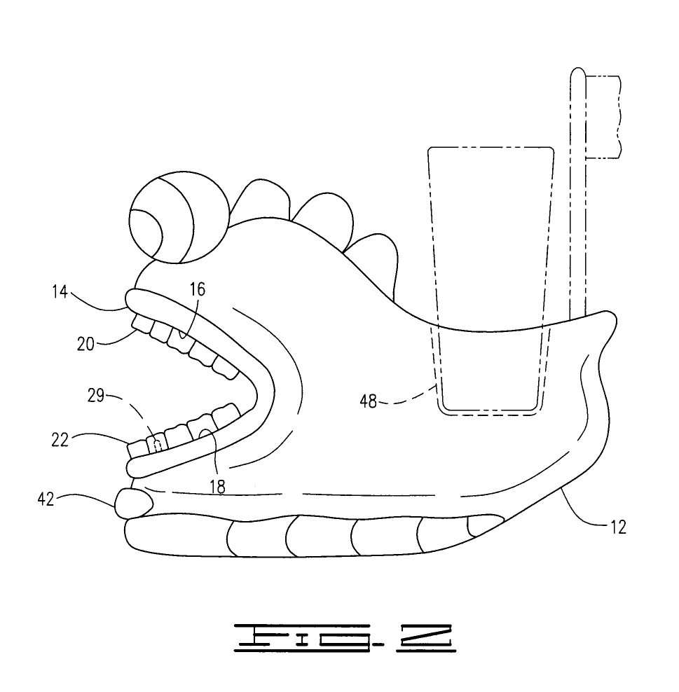

Referring to FIGS. 1 and 2, a three dimensional dental hygiene instructional device 10 constructed in accordance with the inventive concepts disclosed here is illustrated. The device 10 includes a three dimensional FIG. 12 that may be configured to look like a popular and recognizable children's character or a generic character that would be pleasing to children. The three dimensional FIG. 12 has an open mouth 14 with an upper surface 16 and a lower surface 18. The device 10 further includes a plurality of simulated, three dimensional upper teeth 20 and a plurality of simulated, three dimensional lower teeth 22. The upper teeth 20 protrude downwardly from the upper surface 16 of the open mouth 14 in an arc shaped pattern, and the lower teeth 22 protrude upwardly from the lower surface 18 of the open mouth 14 in an arc shaped pattern so that children recognize that the FIG. 12 has a mouth which can be compared to their mouth, without the mouth 14 necessarily being a direct model of a human mouth. Because children are best taught through means that combine visual, audio, and interactive experiences, the device 10 functions to instruct children on how to brush their teeth without it feeling like a chore while bringing to the task audio, visual, and interactive methods.

The upper surface 16 and the lower surface 18 are angled relative to one another so that all the upper teeth 20 and the lower teeth 22 are visible to a child when in use. Each of the upper teeth 20 and the lower teeth 22 are preferably white and translucent so that each of the upper teeth 20 and the lower teeth 22 are cable of transmitting light. Also, each of the upper teeth 20 and the lower teeth 22 are characterized as having a front side 24, a back side 26, and a top side 28. It should be appreciated that the number, size, and spacing of the teeth 20 and 22 may be varied; however, it is preferable that the number of teeth substantially correspond to the number of teeth contained in the mouth of a child. To this end, the upper and lower teeth 20 and 22 may be removable to allow the mouth 14 to mimic the mouth of a child as a child loses his or her deciduous teeth.

In one embodiment, a light emitting source 29 (FIG. 2), such as a light emitting diode (LED), is positioned within each of the upper teeth 20 and the lower teeth 22 in such a way that each of the upper teeth 20 and the lower teeth 22 (only one light emitting source 29 is illustrated in FIG. 2) may be individually illuminated upon activation of the light emitting source to indicate which tooth or teeth should be brushed. In another embodiment, a plurality of light emitting sources may be positioned within each of the upper teeth 20 and the lower teeth 22 in such a way that each of the front side 24, the back side 26, and the top side 28 of the upper and lower teeth 20 and 22 may be independently illuminated.

In one embodiment, the upper teeth 20 and the lower teeth 22 are divided into a plurality of sections such that the teeth of each section are illuminated as a group. For example, the upper teeth 20 may be divided into a first section 30 comprising the upper teeth positioned on a back-left side of the mouth 14, a second section 32 comprising the upper teeth positioned on a front side of the mouth 14, and a third section 34 comprising the upper teeth positioned on a back-right side of the mouth. Likewise, the lower teeth 22 may be divided into a fourth section 36 comprising the lower teeth positioned on a back-left side of the mouth 14, a fifth section 38 comprising the lower teeth positioned on a front side of the mouth 14, and a sixth section comprising the lower teeth positioned on a back-right side of the mouth 14.

In one embodiment, the light emitting sources 29 positioned in the upper and lower teeth may emit a color, and when the upper teeth 20 and the lower teeth 22 are divided into sections, the color of the light emitting sources 29 may be the same for each of the teeth comprising one section with the color of the light emitting sources 29 of the other sections being different. For example, each of the sections 30-38 may emit separate colors, such as red, orange, purple, pink, blue, and green.

In use, each section 30-38 will be caused to illuminate or blink independently for a predetermined period of time, e.g., ten seconds, twice. This will help children brush their teeth for either the recommended minimum of two minutes or a different time as specified by a parent. Each section 30-38 of the mouth 14 may receive an equal amount of brushing time, adding up to two minutes or a different time as selected by the parent. The device 10 may be configured to allow for time intervals of less than two minutes total to account for the shorter attention spans of younger brushers. Regardless of the total time selected, the time is preferably divided by six, so that each section 30-38 of the mouth 14 receives equal treatment.

The device 10 may also contain a count-down clock 41 positioned on the FIG. 12, such as in the open mouth 14 on the lower surface 18. The count-down clock 41 will count-down the time intervals assigned to each section 30-38 of the mouth 14. The device 10 may also include sound emitting functionality that will enable delivery to the children of music and instructions and motivations to brush their teeth well and for the right amount of time. To this end, the device 10 would include a speaker (not shown) from which the music and instructions would emanate. The changing of music may be connected to movement of the blinking teeth around the mouth, i.e., each section 30-38 will have an assigned color and an assigned instruction and musical piece. Parents and children may have the option of turning the sound on and off, including the following settings: (1) music and narration; (2) music only; (3) narration only; or (4) no music and no narration. The device 10 may include a plurality of function buttons 42, 44, and 46 which control the different features of the device 10. For example, the function button 42 may be used to control audible feature, the function button 44 timing features, and the function button 46, which may be located on the eye of the FIG. 12, to initiate a brushing sequence. The device 10 may also include compartments, such as compartment 48, and other means by which accessories, such as toothbrushes, toothpaste and dental floss, can be stored.

The device 10 may also enable the removal and attachment of custom body parts so that children can customize the device to look like a character that is uniquely pleasing to them, but may not be to other children.

The device 10 may also be configured to allow the uploading to it of user-selected music from digital sources, e.g., MP3. In the same vein, the device 10 may be equipped with a recording functionality to allow for children, parents or other users to record their own instructions or narrative.

The device 10 might be configured so that it can communicate wirelessly with a specialized tooth brush so that the device can determine the extent, time, location and correctness of a user's brushing and communicate back to the user any need for additional brushing. The device 10 may also include a mirror (not shown) or other reflective surface so that children can watch themselves brush their teeth. The device 10 may also include a gaming component by which the child could be challenged to, e.g., follow specific patterns of brushing for specific amounts of time.

The device 10 includes a controller to control the various features and parameters of the device 10, including the light emitting sources 29 to sequentially control the illumination of the light emitting sources 29 during successive intervals of time, the count-down clock 40, and the audio features. It should be appreciated that the controller may include a variety of electric circuits to drive the light emitting sources 29, count-down clock 40, and other functions. By way of example, circuits that might be used are disclosed in U.S. Pat. Nos. 4,934,940 and 5,810,601, both of which are hereby expressly incorporated herein by reference.

The foregoing embodiments provide a device that is easily useable and provides a visual display for promoting dental hygiene which both attracts and maintains the attention of children while passing and distributing their teeth brushing effort throughout the interior and exterior dental surfaces of the upper and lower jaws.

From the above description, it is clear that the inventive concepts disclosed and claimed herein are well adapted to carry out the objects and to attain the advantages mentioned herein, as well as those inherent in the invention. While presently preferred embodiments of the inventive concepts have been described for purposes of this disclosure, it will be understood that numerous changes may be made which will readily suggest themselves to those skilled in the art and which are accomplished within the spirit of the inventive concepts disclosed and/or as defined in the appended claims.

What is claimed is:

1. A dental hygiene instructional device, comprising:
a three dimensional figure with an open mouth, the open mouth having an upper surface and a lower surface;
a plurality of simulated, three dimensional upper teeth protruding downwardly from the upper surface of the open mouth in an arc shaped pattern, each of the upper teeth being capable of transmitting light;
a plurality of simulated, three dimensional lower teeth protruding upwardly from the upper surface of the open mouth in an arc shaped pattern, each of the lower teeth being capable of transmitting light;
at least one light emitting source positioned within each of the upper teeth and the lower teeth so that each of the upper teeth and the lower teeth may be individually illuminated; and
a controller connected to the light emitting sources to sequentially control the illumination of the light emitting sources during successive intervals of time.

2. The dental hygiene instructional device of claim 1, wherein each of the upper teeth and the lower teeth have a front side, a back side, and a top side, and wherein a plurality of light emitting sources are positioned within each of the upper teeth and the lower teeth in such a way that each of the front side, the back side, and the top side of the upper and lower teeth may be independently illuminated.

3. The dental hygiene instructional device of claim 1, wherein the upper teeth are divided into a first section comprising the upper teeth positioned on a back-left side of the mouth, a second section comprising the upper teeth positioned on a front side of the mouth, a third section comprising the upper teeth positioned on a back-right side of the mouth, a fourth section comprising the lower teeth positioned on a back-left side of the mouth, a fifth section comprising the lower teeth positioned on a front side of the mouth, a sixth section comprising the lower teeth positioned on a back-right side of the mouth, and wherein the teeth of each section are illuminated as a group.

4. The dental hygiene instructional device of claim 3 wherein the light emitting sources positioned in the upper and lower teeth emit a color, and wherein the color of the light emitting sources is the same for each of the teeth comprising one of the six sections, but the color of the light emitting sources of each section is different from the color of the light emitting sources of the other sections.

5. The dental hygiene instructional device of claim 1 further comprising a timer display positioned in the mouth between the upper teeth and the lower teeth.

6. The dental hygiene instructional device of claim 1, wherein each of the upper teeth are removable from the upper surface and each of the lower teeth are removable from the lower surface.
